(19) United States
(12) Patent Application Publication
(10) Pub. No.: US 2005/0075880 A1
(43) Pub. Date: Apr. 7, 2005

(54) Method, system, and product for automatically modifying a tone of a message

(75) Inventors: Clifford A. Pickover, Yorktown Heights, NY (US); Paul Andrew Moskowitz, Yorktown Heights, NY (US); William Gray, Millwood, NY (US); Peter George Capek, Ossining, NY (US)

Correspondence Address: Duke W. Yee;Carstens, Yee & Cahoon, LLP, P.O. Box 802334, Dallas, TX, 75380, US

(73) Assignee: International Business Machines Corporation, Armonk, NY (US)

(21) Appl. No.: 10/055,476

(22) Filed: Jan. 22, 2002

(51) Int. Cl. G10L 21/00

(52) U.S. Cl. 704/270

(57) ABSTRACT

A data processing system, method, and product are disclosed for automatically changing a tone of a message. A particular tone is specified. The data processing system determines an original tone of the message. A determination is then made by the data processing system as to whether the original tone is the particular tone. The data processing system then automatically modifies the message without user input to change the original tone to the particular tone in response to a determination that the original tone is not the particular tone.

### BACKGROUND OF THE INVENTION

1. Technical Field

The present invention relates generally to an improved data processing system, and more particularly to a method, system, and product for automatically changing a tone of a message. Still further, the present invention relates to a data processing system, method, and product for automatically modifying a message without user input to change an original tone of the message to a particular tone in response to a determination that the original tone is not the particular tone.

2. Description of Related Art

Spelling checkers are known in the art. These software programs typically test each word in the text of an electronic document to determine whether the word is included within a dictionary included in the spelling checker. If the spelling checker encounters a word that is not in its dictionary, the spelling checker offers suggestions for correcting the spelling problem. The user may then either select a suggested word, edit the misspelled word, or ignore the error.

Grammar checkers are also known in the art. Grammar checkers operate in a manner similar to spelling checkers. Grammar checkers check the grammar in a sentence. Written electronic communications convey little of the nuance of face-to-face or verbal communications. In order to solve this problem, various emotion-conferring symbols have been introduced, such as “:-)” often called emoticons.

These symbols, however, are cumbersome to use and lack in formality. Neither spelling checkers nor grammar checkers check a document's tone.

Therefore, it would be advantageous to have a method, system, and product for automatically determining and changing a tone of a message.

### SUMMARY OF THE INVENTION

A data processing system, method, and product are disclosed for automatically changing a tone of a message. A particular tone is specified. The data processing system determines an original tone of the message. A determination is then made by the data processing system as to whether the original tone is the particular tone. The data processing system then automatically modifies the message, without requiring any user input, to change the original tone to the particular tone in response to a determination that the original tone is not the particular tone.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a data processing system that may be implemented as a server in accordance with the present invention;

FIG. 3 is a block diagram of a data processing system that may be implemented as a client in accordance with the present invention;

FIG. 4 depicts a high level flow chart which illustrates automatically changing a tone of a message in accordance with the present invention; and

FIG. 5 illustrates a high level flow chart which illustrates user preferences and default values to use to automatically change a tone of a message in accordance with the present invention.

### DETAILED DESCRIPTION OF THE PREFERRED EMBODIMENT

The invention is preferably realized using a well-known computing platform, such as an IBM RS/6000 workstation running the IBM AIX operating system. However, it may be realized in other popular computer system platforms, such as an IBM personal computer running the Microsoft Windows operating system or a Sun Microsystems workstation running operating systems such as UNIX or LINUX, without departing from the spirit and scope of the invention.

The present invention is a method, system, and product for automatically changing a tone of a message. The tone of a document is partially determined by the words chosen to convey the message. For example, the following message has a neutral tone: “Cliff, We will meet on Tuesday next week. Paul”. The tone of this message can be changed to a formal tone by changing some of the words as well as adding and/or deleting words as in the following example: “Dear Cliff, I must inform you that we will meet on Tuesday this week. Sincerely, Paul.”

A formal tone may be achieved by following an established form, custom, convention, or rule. In contrast, an informal tone may be achieved by using text that is characteristic of or appropriate to ordinary, casual, or familiar use.

The following message has a formal tone:
Dear Dr. Pickover,
   We are pleased to inform you that your technical book on fiber optics has exceeded the threshold of 50,000 books sold. I am enthusiastic,
Sincerely,
William Penn, Ph.D.
Attorney at Law

The same text may be presented informally as in the following example:

Hey, Cliff, Good news! Your book on lava lamps is a big hit. I'm happy.—Bill The informal message uses a different format for presenting the information, does not have an address, uses slang for the salutation, does not include a title in the signature line, uses personal names, and uses contractions.

A text having an authoritative tone suggests that the creator or sender is entitled to obedience, credit, or acceptance. Such text may even have dictatorial suggestions. The following is such an example of an authoritative text:
Dear Dr. Smith,
   As you know, I am the world expert on optics. It is imperative that you send me your paper tomorrow. I look forward to your quick attention to this matter.

Lou

A message having a happy tone may suggest that the creator or sender is favored by luck or fortune, is enjoying a feeling of well-being and contentment, or is otherwise joyous. For example:

Joe, this is my big day! Come to my house for dinner. Let's celebrate. Love, Sue.

A message having an angry tone may suggest that the creator or sender has a strong feeling of displeasure or is antagonistic. In addition, the sender or creator may be indignant and exhibit a righteous anger at what he or she considers unfair, mean, or shameful. As an example, curse words or near-curse words may be used. A message having an angry tone may be unsigned to suggest a hasty or ungracious feeling. For example:

Joe, you should know I am terribly upset by what you have done. There is no way in hell that this was the right approach to solving the problem. (unsigned) Tone may be ascertained and converted using various criteria and methods. For example, tone may be inferred from the presence of four kinds of sentences: declarative, imperative, interrogative, and exclamatory. Similarly, a degree of a particular tone may be ascertained and converted in the same manner. For example, an extremely hostile tone could be converted to a merely hostile tone by changing only some of the hostile elements.

A declarative sentence makes a statement and has a neutral tone. The following is an example of a declarative sentence: “The money is due tomorrow”.

An imperative sentence gives a command or makes a request. This type of sentence suggests a tone of authority. The following is an example of an imperative sentence: “Give me the money now”. When such an authoritative tone is not desired, an imperative sentence could be changed to either a declarative or interrogative sentence.

An interrogative sentence asks a question. This type of sentence suggests a tone of seeking information. The following is an example of an interrogative sentence: “Do you have the money?”.

An exclamatory sentence shows strong feeling. The following is an example of an imperative sentence: “The money is due tomorrow!”. Declarative and imperative sentences can be changed into exclamatory sentences by changing the punctuation and adding an exclamation point.

The tone of a message may be changed by adding words, such as “please” or “thank you”, deleting words, such as expletives, or changing informal phrases into formal phrases. Phrases such as “I need” or “suggest” also affect the tone of a message.

The present invention describes determining a tone, as well of the degree of the tone, by dividing the message into elements, and evaluating each element's tone. The size of an element may be a sentence, a paragraph, the entire body of the message, or any other part of the message including the entire message. Further, the percentage of each type of sentence included within a message also determines a tone of the message. For example, if the element of a message includes a paragraph, the number of each type of sentence which is included within the paragraph can be determined. If all of the sentences included in the paragraph are exclamatory sentences, the tone of the paragraph is very strong and can be softened by changing some of the sentences into declarative sentences.

FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

In the depicted example, a server 104 is connected to network 102 along with storage unit 106. In addition, clients 108, 110, and 112 also are connected to network 102. These clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104.

Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

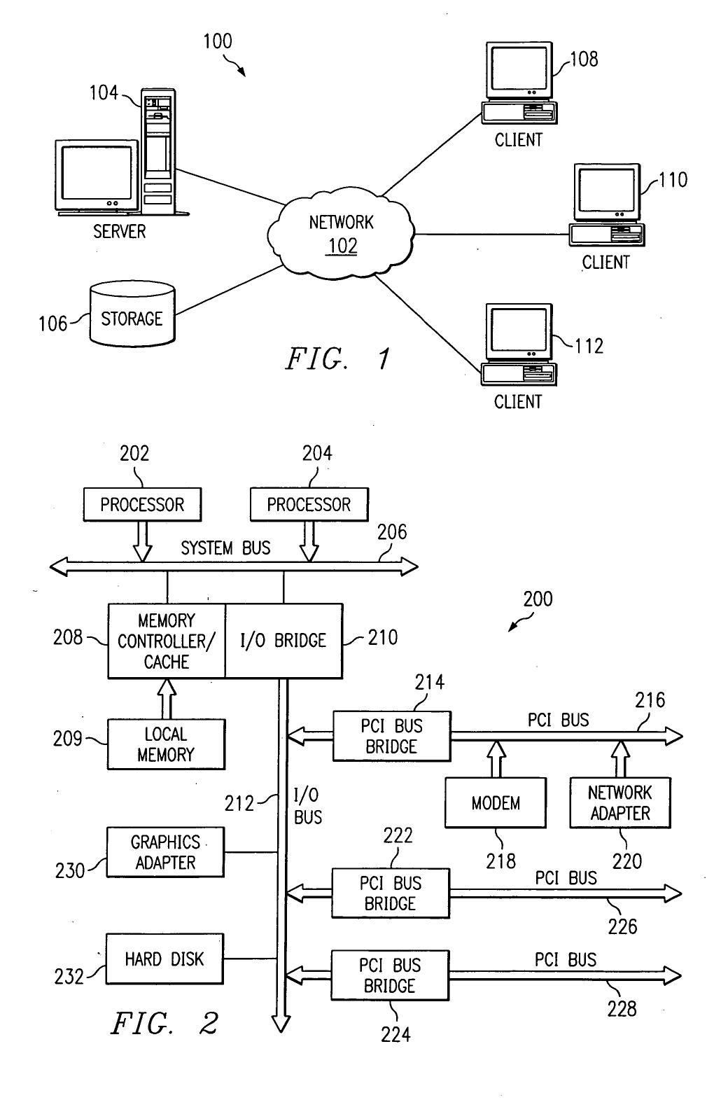

FIG. 2 is a block diagram of a data processing system that may be implemented as a server in accordance with the present invention. Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

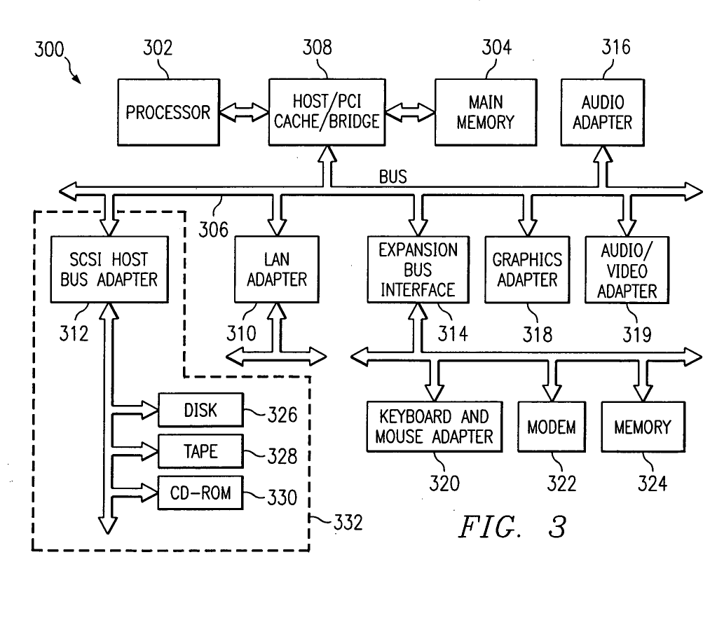

FIG. 3 is a block diagram illustrating a data processing system that may be implemented as a client in accordance with the present invention. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors. An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

Data processing system 300 may take various forms, such as a stand-alone computer or a networked computer. As a further example, data processing system 300 may be a personal digital assistant (PDA) device, which is configured with ROM and/or flash ROM in order to provide nonvolatile memory for storing operating system files and/or user-generated data. The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

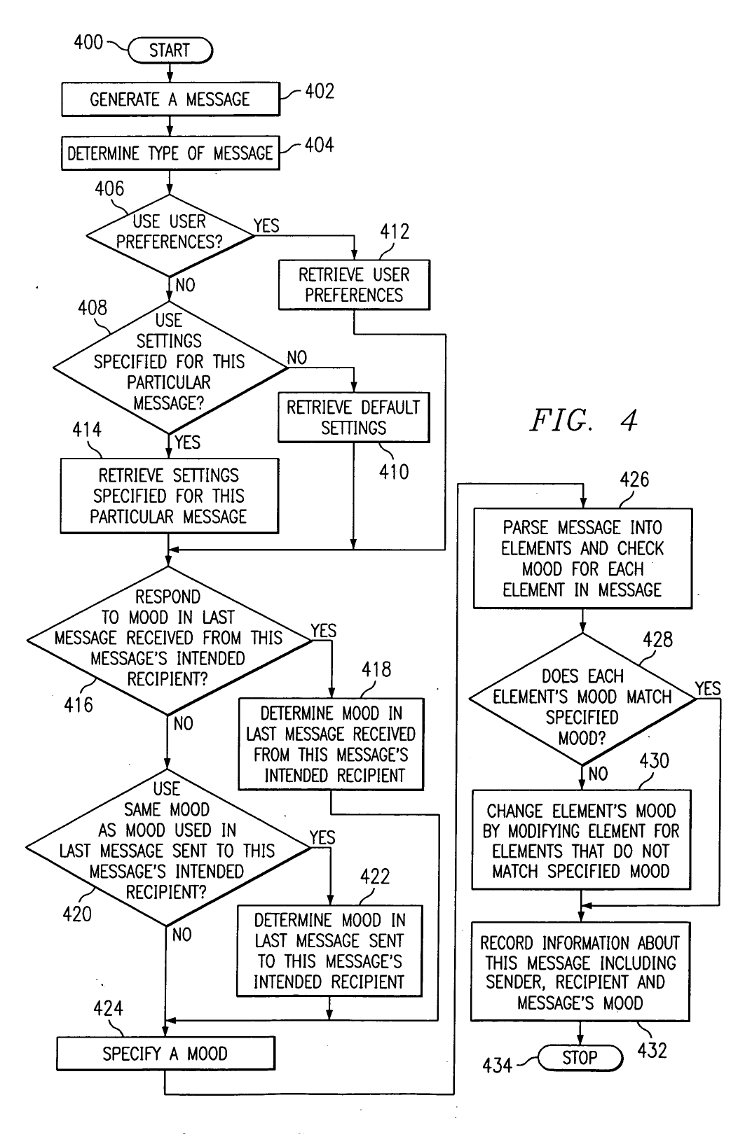

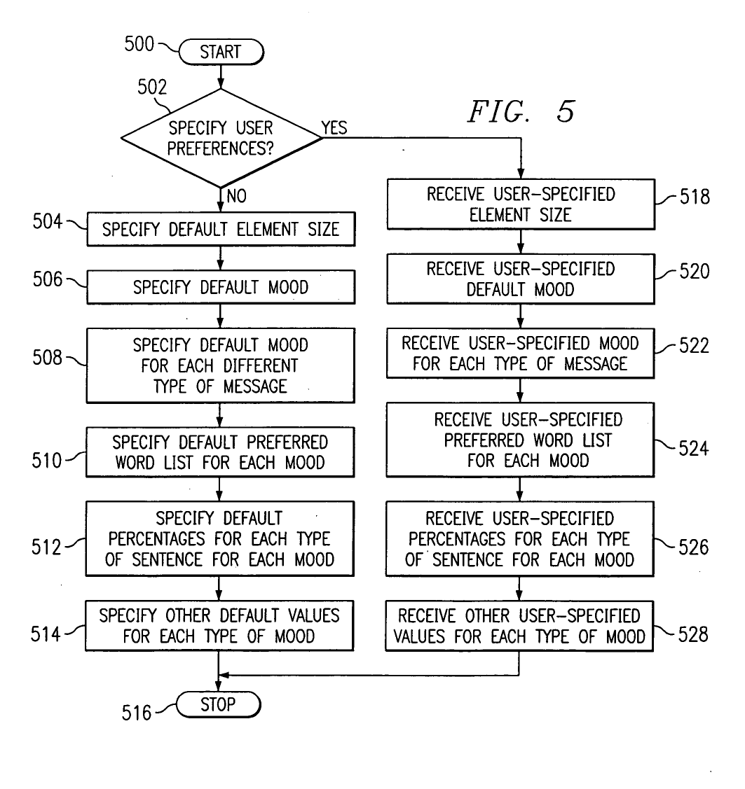

FIG. 4 illustrates a high level flow chart which depicts automatically changing a tone of a message in accordance with the present invention. The process starts as depicted by block 400 and thereafter passes to block 402 which illustrates generating a message. The term “message” includes any type of message, such as textual messages, e-mail messages, instant messages, HTML messages, pager message, phone calls, electronically generated speech, or any other type of message or communication. Next, block 404 depicts the data processing system determining a type for the generated message. Any method may be used to classify messages into different types. For example, the type could include formal, informal, personal, advertisement, business, or other types of messages.

The process then passes to block 406 which illustrates a determination of whether or not user preferences should be used to detect and change a tone of a message. If a determination is made that user preferences should not be used, the process passes to block 408 which illustrates a determination of whether or not settings specified for this particular message should be used. If a determination is made that settings specified for this particular message should not be used, the process passes to block 410 which depicts retrieving default settings. These settings are described in more detail below in the description of FIG. 5. Thereafter, the process passes to block 416.

Referring again to block 412, if a determination is made that user preferences are to be used, the process passes to block 412 which illustrates retrieving user specified preferences. User preferences are described in more detail below. The process then passes to block 416.

Referring again to block 414, if a determination is made that settings specified for this particular message are to be used, the process passes to block 414 which illustrates retrieving settings to be used for this particular message. The process then passes to block 416.

Block 416, then, depicts a determination of whether or not the type and degree of the tone of this message should respond to the type and degree of the tone of the last message received from this message's intended recipient. If a determination is made that the type and degree of the tone of this message should respond to the type and the degree of the tone of the last message received from this message's intended recipient, the process passes to block 418 which illustrates determining the type and degree of the tone of the last message received from this message's intended recipient. The process then passes to block 424.

Referring again to block 416, if a determination is made that the type and the degree of the tone of this message does not need to respond to the type and the degree of the tone of the last message received from this message's intended recipient, the process passes to block 420 which depicts a determination of whether or not the type and the degree of the tone of this message should use the same type and degree of tone as the type and degree of tone used in the last message sent to this message's intended recipient. If a determination is made that this message should use the type and degree of tone used in the last message sent to this message's intended recipient, the process passes to block 422 which illustrates determining the type and degree of tone of the last message sent to this message's intended recipient. The process then passes to block 424.

Referring again to block 420, if a determination is made that this message does not need to use the type and degree of tone used in the last message sent to this message's intended recipient, the process passes to block 424.

Block 424, then, illustrates specifying a type and degree of tone to use for this message. Any type of tone may be specified, such as formal, informal, happy, unhappy, authoritative, angry, or other type of tone. This tone is either a tone specified within user preferences, the tone of the last message received from this message's intended recipient, the tone used in the last message sent to this message's intended recipient, a tone specified especially for this particular message, or a tone specified by the default settings.

Further, a degree of the tone may be specified. For example, a hostile message may be extremely hostile, hostile, or mildly hostile. Similarly, a friendly message may be extremely friendly, friendly, or mildly friendly. The degree of a message may be detected and modified by changing only a portion of the elements which contribute to the type of message. For example, an extremely friendly message could be modified to be a mildly friendly message by changing most, but not all, of the elements which cause the message to have a friendly tone.

Next, block 426 depicts parsing the message into a plurality of elements and checking the tone of each element in this message. The size of an element may be a word, a sentence, a paragraph, the entire body of the message, or any other part of the message including the entire message. The identification of an element size is described in more detail below.

The process then passes to block 428 which illustrates a determination of whether or not the tone of each element matches the specified tone. If a determination is made that the tone of each element does match the specified tone, the process passes to block 432. Referring again to block 428, if a determination is made that the tone of one or more elements does not match the specified tone, the process passes to block 430 which depicts changing the element's type and/or degree of tone by modifying the element. The element may be modified by changing the text of the element, changing punctuation included in the element, changing the font color used to display the element, added words to or deleting words from the element, or any other change which produces the specified tone.

If the element is a paragraph or the entire body of the message, the tone can be changed by changing sentence types. For example, each sentence type within the message could be identified. Then using the percentages, only some of the sentence types could be changed. For example, if a message requires a formal tone, a very low percentage of interrogative sentences, such as not to exceed 5%, and a high percentage of declarative sentences, such as 90%, with the remaining 5% being imperative and exclamatory sentences might be specified. If, after checking a message, the percentage of interrogative sentences is found to be 15%, some of these sentences could be changed to declarative sentences to reduce the percentage to 5%.

Preferred words lists can be used. These preferred words can be added to the message, or used when a new word must be chosen to replace an inappropriate word. The process is repeated for each element that has a tone that is not the specified tone.

Thereafter, block 432 illustrates recording information about this message, such as sender, recipient, and the message's type and degree of tone. The process then terminates as depicted by block 434.

FIG. 5 depicts a high level flow chart which illustrates user preferences and default values to use to automatically change a tone of a message in accordance with the present invention. The process starts as depicted by block 500 and thereafter passes to block 502 which illustrates a determination of whether or not user preferences are to be specified. If a determination is made that user preferences are not to be specified, the process passes to block 504 which depicts specifying a default element size. The element size may be a word, a sentence, a paragraph, collection of paragraphs, the body of a message, the entire message including addresses, salutation, closing, or any portion of a message. Block 506, then, illustrates specifying a default tone. Next, block 508 depicts specifying a default tone for each different type of message. For example, a formal tone may be specified for formal letters, while a business formal mode is specified for business letters, and a casual mode is specified for personal letters. The process then passes to block 510 which illustrates specifying a default preferred word list for each tone. Particular words can be specified for each tone. The words could then be inserted into a message or deleted from a message to change the tone of the message. For example, use of the words “please” and “thank you” will change the tone of a message. The addition of particular adjectives, adverbs, or other types of words, can also change the tone of a message.

Next, block 512 depicts specifying default percentages for each type of sentence for each tone. Thereafter, block 514 illustrates specifying any other type of default value or information that may be used to detect a particular tone and to change the tone of a message. For example, particular types of punctuation, particular fonts, particular font size, font color, background color, or sounds may be associated with a particular tone. Particular scents could be associated with a tone. These associations may be specified and then used both to detect a particular tone and to change a message in order to change the tone of the message. The process then terminates as depicted by block 516.

Referring again to block 502, if a determination is made that user preferences are to be specified, the process passes to block 518 which illustrates receiving a user-specified element size. Next, block 520 depicts receiving a user-specified default tone. Thereafter, block 522 illustrates receiving a user-specified tone for each type of message. The process then passes to block 524 which depicts receiving a user-specified word list for each tone. Next, block 526 illustrates receiving user-specified percentages for each type of sentence for each tone. Thereafter, block 528 illustrates receiving any other type of user-specified value or information that may be used to detect a particular tone and to change the tone of a message. The process then terminates as depicted by block 516.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system, said method comprising the steps of:
specifying a particular tone;
determining, utilizing said data processing system, an original tone of a message;
determining, utilizing said data processing system, whether said original tone is said particular tone; and
automatically modifying, utilizing said data processing system, said message to change said original tone to said particular tone in response to a determination that said original tone is not said particular tone.

2. The method according to claim 1, further comprising the steps of:
parsing said message into a plurality of elements; and
determining, utilizing said data processing system, an original tone of a message by determining a tone of each of said plurality of elements.

3. The method according to claim 2, further comprising the step of specifying a size of each of said plurality of elements.

4. The method according to claim 3, further comprising the step of parsing said message into a plurality of words, wherein said size of each of said plurality of elements is a word.

5. The method according to claim 3, further comprising the step of parsing said message into a plurality of sentences, wherein said size of each of said plurality of elements is a sentence.

6. The method according to claim 3, further comprising the step of parsing said message into a plurality of paragraphs, wherein said size of each of said plurality of elements is a paragraph.

7. The method according to claim 1, further comprising the step of automatically modifying said message by adding words to said message.

8. The method according to claim 1, further comprising the step of automatically modifying said message by deleting words from said message.

9. The method according to claim 1, further comprising the step of automatically modifying said message by changing punctuation in said message.

10. The method according to claim 1, further comprising the step of automatically modifying said message by changing a font of said message.

11. The method according to claim 1, wherein said step of specifying a particular tone further comprises the step of specifying a formal tone.

12. The method according to claim 1, wherein said step of specifying a particular tone further comprises the step of specifying an informal tone.

13. The method according to claim 1, wherein said step of specifying a particular tone further comprises the step of specifying an authoritative tone.

14. The method according to claim 1, wherein said step of specifying a particular tone further comprises the step of specifying a happy tone.

15. The method according to claim 1, wherein said step of specifying a particular tone further comprises the step of specifying an angry tone.

16. The method according to claim 1, further comprising the step of parsing said message into a plurality of elements, wherein one of said plurality of elements is an entire body of said message.

17. The method according to claim 1, further comprising the step of:
identifying a recipient of said message;
determining a tone of a last message sent to said recipient; and
utilizing said tone of said last message as said particular tone.

18. The method according to claim 1, further comprising the steps of:
generating said message as a reply to a sender's message;
determining, utilizing said data processing system, a tone of said sender's message; and
utilizing said tone of said sender's message as said particular tone.

19. The method according to claim 1, further comprising the steps of:
specifying a particular type of tone;
determining, utilizing said data processing system, an original type of tone of a message;
determining, utilizing said data processing system, whether said original type of tone is said particular type of tone; and
automatically modifying, utilizing said data processing system, said message to change said original type of tone to said particular type of tone in response to a determination that said original type of tone is not said particular type of tone.

20. A method in a data processing system, said method comprising the steps of:
specifying a particular tone including a particular degree of said tone;
determining, utilizing said data processing system, an original tone of a message including a degree of said original tone;
determining, utilizing said data processing system, whether said original tone is said particular tone;
automatically modifying, utilizing said data processing system, said message to change said original tone to said particular tone including said degree of said tone in response to a determination that said original tone is not said particular tone;
in response to a determination that said original tone is said particular tone, determining, utilizing said data processing system, whether said degree of said original tone is said particular degree of said specified tone, and
automatically modifying, utilizing said data processing system, said message to change said degree of said original tone to said degree of said particular tone in response to a determination that said degree of said original tone is not said particular degree of said particular tone.

21. A computer program product in a data processing system, said computer program product comprising:
instruction means for specifying a particular tone;
instruction means for determining, utilizing said data processing system, an original tone of a message;
instruction means for determining, utilizing said data processing system, whether said original tone is said particular tone; and
instruction means for automatically modifying, utilizing said data processing system, said message to change said original tone to said particular tone in response to a determination that said original tone is not said particular tone.

22. The product according to claim 21, further comprising:
instruction means for parsing said message into a plurality of elements; and
instruction means for determining, utilizing said data processing system, an original tone of a message by determining a tone of each of said plurality of elements.

23. The product according to claim 22, further comprising instruction means for specifying a size of each of said plurality of elements.

24. The product according to claim 23, further comprising instruction means for parsing said message into a plurality of words, wherein said size of each of said plurality of elements is a word.

25. The product according to claim 23, further comprising instruction means for parsing said message into a plurality of sentences, wherein said size of each of said plurality of elements is a sentence.

26. The product according to claim 23, further comprising instruction means for parsing said message into a plurality of paragraphs, wherein said size of each of said plurality of elements is a paragraph.

27. The product according to claim 21, further comprising instruction means for automatically modifying said message by adding words to said message.

28. The product according to claim 21, further comprising instruction means for automatically modifying said message by deleting words from said message.

29. The product according to claim 21, further comprising instruction means for automatically modifying said message by changing punctuation in said message.

30. The product according to claim 21, further comprising instruction means for automatically modifying said message by changing a font of said message.

31. The product according to claim 21, wherein said instruction means for specifying a particular tone further comprises instruction means for specifying a formal tone.

32. The product according to claim 21, wherein said instruction means for specifying a particular tone further comprises instruction means for specifying an informal tone.

33. The product according to claim 21, wherein said instruction means for specifying a particular tone further comprises the step of specifying an authoritative tone.

34. The product according to claim 21, wherein said instruction means for specifying a particular tone further comprises the step of specifying a happy tone.

35. The product according to claim 21, wherein said instruction means for specifying a particular tone further comprises the step of specifying an angry tone.

36. The product according to claim 21, further comprising instruction means for parsing said message into a plurality of elements, wherein one of said plurality of elements is an entire body of said message.

37. The product according to claim 21, further comprising:
instruction means for identifying a recipient of said message;
instruction means for determining a tone of a last message sent to said recipient; and
instruction means for utilizing said tone of said last message as said particular tone.

38. The product according to claim 21, further comprising:
instruction means for generating said message as a reply to a sender's message;
instruction means for determining, utilizing said data processing system, a tone of said sender's message; and
instruction means for utilizing said tone of said sender's message as said particular tone.

39. The product according to claim 21, further comprising:
instruction means for specifying a particular type of tone;
instruction means for determining, utilizing said data processing system, an original type of tone of a message;
instruction means for determining, utilizing said data processing system, whether said original type of tone is said particular type of tone; and
instruction means for automatically modifying, utilizing said data processing system, said message to change said original type of tone to said particular type of tone in response to a determination that said original type of tone is not said particular type of tone.

40. A computer program product in a data processing system, said computer program product comprising:
instruction means for specifying a particular tone including a particular degree of said tone;
instruction means for determining, utilizing said data processing system, an original tone of a message including a degree of said original tone;
instruction means for determining, utilizing said data processing system, whether said original tone is said particular tone;
instruction means for automatically modifying, utilizing said data processing system, said message to change said original tone to said particular tone including said degree of said tone in response to a determination that said original tone is not said particular tone;
in response to a determination that said original tone is said particular tone, instruction means for determining, utilizing said data processing system, whether said degree of said original tone is said particular degree of said specified tone, and
instruction means for automatically modifying, utilizing said data processing system, said message to change said degree of said original tone to said degree of said particular tone in response to a determination that said degree of said original tone is not said particular degree of said particular tone.

41. A data processing system comprising:
a particular tone being specified;
said data processing system including a CPU executing code for determining an original tone of a message;
said CPU executing code for determining whether said original tone is said particular tone; and
said data processing system for automatically modifying said message to change said original tone to said particular tone in response to a determination that said original tone is not said particular tone.

42. The system according to claim 1, further comprising:
said message being parsed into a plurality of elements; and
said CPU executing code for determining an original tone of a message by determining a tone of each of said plurality of elements.

43. The system according to claim 42, further comprising a size of each of said plurality of elements being specified.

44. The system according to claim 43, further comprising said message being parsed into a plurality of words, wherein said size of each of said plurality of elements is a word.

45. The system according to claim 43, further comprising said message being parsed into a plurality of sentences, wherein said size of each of said plurality of elements is a sentence.

46. The system according to claim 43, further comprising said message being parsed into a plurality of paragraphs, wherein said size of each of said plurality of elements is a paragraph.

47. The system according to claim 41, further comprising said CPU executing code for automatically modifying said message by adding words to said message.

48. The system according to claim 41, further comprising said CPU executing code for automatically modifying said message by deleting words from said message.

49. The system according to claim 41, further comprising said CPU executing code for automatically modifying said message by changing punctuation in said message.

50. The system according to claim 41, further comprising said CPU executing code for automatically modifying said message by changing a font of said message.

51. The system according to claim 41, wherein said specified particular tone is a formal tone.

52. The system according to claim 41, wherein said specified particular tone is an informal tone.

53. The system according to claim 41, wherein said specified particular tone is an authoritative tone.

54. The system according to claim 41, wherein said specified particular tone is a happy tone.

55. The system according to claim 41, wherein said specified particular tone is an angry tone.

56. The system according to claim 41, further comprising said message being parsed into a plurality of elements, wherein one of said plurality of elements is an entire body of said message.

57. The system according to claim 41, further comprising:
a recipient of said message being identified;
said CPU executing code for determining a tone of a last message sent to said recipient; and
said tone of said last message being utilized as said particular tone.

58. The system according to claim 41, further comprising:
said message being generated as a reply to a sender's message;
said CPU executing code for determining a tone of said sender's message; and
said tone of said sender's message being utilized as said particular tone.

59. The system according to claim 41, further comprising:
a particular type of tone being specified;
said CPU executing code for determining an original type of tone of a message;
said CPU executing code for determining whether said original type of tone is said particular type of tone; and
said CPU executing code for automatically modifying said message to change said original type of tone to said particular type of tone in response to a determination that said original type of tone is not said particular type of tone.

60. A data processing system comprising:
a particular tone including a particular degree of said tone being specified;
said data processing system including a CPU executing code for determining an original tone of a message including a degree of said original tone;
said CPU executing code for determining whether said original tone is said particular tone;
said CPU executing code for automatically modifying said message to change said original tone to said particular tone including said degree of said tone in response to a determination that said original tone is not said particular tone;
in response to a determination that said original tone is said particular tone, said CPU executing code for determining whether said degree of said original tone is said particular degree of said specified tone, and
said CPU executing code for automatically modifying said message to change said degree of said original tone to said degree of said particular tone in response to a determination that said degree of said original tone is not said particular degree of said particular tone.
